(19) United States
(12) Patent Application Publication
(10) Pub. No.: US 2026/0122362 A1
(43) Pub. Date: Apr. 30, 2026

(54) IMAGE SENSOR USING METHOD OF DRIVING HYBRID SHUTTER SHARING STORAGE AREA

(71) Applicant: Samsung Electronics Co., Ltd., Suwon-si (KR)

(72) Inventors: Eun Sub SHIM, Suwon-si (KR); Jaeho LEE, Suwon-si (KR)

(73) Assignee: Samsung Electronics Co., Ltd., Suwon-si (KR)

(21) Appl. No.: 19/292,365

(22) Filed: Aug. 6, 2025

(30) Foreign Application Priority Data
Oct. 28, 2024 (KR) 10-2024-0148550

(51) Int. Cl. H04N 25/42; H04N 25/50; H04N 25/771; H04N 25/78

(52) U.S. Cl. CPC H04N 25/42; H04N 25/50; H04N 25/771; H04N 25/78

(57) ABSTRACT

Disclosed is an image sensor, which includes a first photodiode, a second photodiode, a storage area including a first capacitor and a second capacitor, a first pixel signal generator circuit configured to convert a voltage corresponding to a charge of the first photodiode stored in the storage area into a first pixel signal based on a first mode signal, and a second pixel signal generator circuit configured to convert a voltage corresponding to a charge of the first photodiode into a second pixel signal based on a second mode signal, and the first pixel signal generator circuit configured to transfer at least a part of the charge of the first photodiode to the storage area based on the second mode signal.

### CROSS-REFERENCE TO RELATED APPLICATIONS

This application claims priority under 35 U.S.C. § 119 to Korean Patent Application No. 10-2024-0148550 filed on Oct. 28, 2024, in the Korean Intellectual Property Office, the disclosures of which are incorporated by reference herein in their entireties.

### BACKGROUND

Example embodiments of the present disclosure described herein relate to image sensors, and more particularly, relate to image sensors of a hybrid shutter driving method that share a storage area.

Image sensors may convert light received through photodiodes into electrical signals. Complementary Metal Oxide Semiconductor (CMOS) image sensors have various advantages over other image sensors, such as being easy or simple to operate, consuming less power, and allowing signal processing circuits to be integrated into a single chip.

As the use of CMOS image sensors rapidly increases, there is a desire for image sensors that improve performance while maintaining size or are miniaturized/reduced in size while maintaining performance is increasing.

### SUMMARY

Example embodiments of the present disclosure provide image sensors of a hybrid shutter driving method sharing a storage area.

According to some example embodiments of the present disclosure, an image sensor includes a first photodiode, a second photodiode, a storage area including a first capacitor and a second capacitor, a first pixel signal generator circuit that converts a voltage corresponding to a charge of the first photodiode stored in the storage area into a first pixel signal based on a first mode signal, and a second pixel signal generator circuit that converts a voltage corresponding to a charge of the first photodiode into a second pixel signal based on a second mode signal, and based on the first mode signal, a pixel signal corresponding to the first photodiode and a pixel signal corresponding to the second photodiode are simultaneously read out, based on the second mode signal, the pixel signal corresponding to the first photodiode and the pixel signal corresponding to the second photodiode are sequentially read out, and the first pixel signal generator circuit is configured to transfer at least a part of the charge of the first photodiode to the storage area based on the second mode signal.

According to some example embodiments of the present disclosure, an image sensor includes a first capacitor, a second capacitor, a first transistor connected between a photodiode and a floating diffusion node and having a gate configured to receive a transmission signal, a second transistor connected between a first node and the floating diffusion node and having a gate configured to receive a first reset signal, a third transistor connected between the first node and a first power terminal and having a gate configured to receive a second reset signal, a fourth transistor connected between the first power terminal and a second power terminal and including a gate configured to receive a third reset signal, a fifth transistor connected between a third power terminal and a second node and having a gate connected to the floating diffusion node, a sixth transistor connected between the second node and a first column line and having a gate configured to receive a selection signal, a seventh transistor connected between the second node and a storage node and having a gate configured to receive a switch signal, an eighth transistor connected between the storage node and one end of the first capacitor and having a gate configured to receive a first sampling signal, a ninth transistor connected between the storage node and one end of the second capacitor and having a gate configured to receive a second sampling signal, and a tenth transistor connected between the first node and the second node, or connected between the first node and the storage node and having a gate configured to receive a second switch signal, and another end of the first capacitor and another end of the second capacitor are respectively connected to the second power terminal.

According to some example embodiments of the present disclosure, an image sensor includes a storage area including a first capacitor and a second capacitor, the storage area is configured to store, in a global shutter method, a charge overflowing from a photodiode is, and transfer, in a rolling shutter method, a charge overflowing from the photodiode to at least one of the first capacitor or the second capacitor, and a floating diffusion region.

According to some example embodiments of the present disclosure, an image capturing method includes determining whether to operate in a first method or a second method, transmitting a first mode signal, based on determining to operate in the first method, or a second mode signal, based on determining to operate in the second method, to a pixel circuit, collecting charges in a photodiode of the pixel circuit during an exposure time, based on the pixel circuit receiving the first mode signal, storing charges of the floating diffusion region of the pixel circuit in a storage area of the pixel circuit, and converting a voltage corresponding to the stored charge into a first pixel signal, based on the pixel circuit receiving the second mode signal, storing at least some of the floating diffusion region of the pixel circuit in the storage area of the pixel corresponding to the charge of the floating diffusion region into the second pixel signal, and converting a voltage corresponding to a charge of an extended floating diffusion region into the third pixel signal, outputting at least one of the first to third pixel signals, and converting the output at least one of the first to third pixel signals into respective digital signals. The storage area including a first capacitor and the second capacitor.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating an image sensor, according to some example embodiments of the present disclosure.

FIG. 2 is a diagram illustrating a global shutter method.

FIG. 3 is a diagram illustrating a rolling shutter method.

FIG. 4 is a diagram illustrating an image sensor, according to some example embodiments of the present disclosure.

FIG. 5 is a detail block diagram of a first pixel circuit of FIG. 4.

FIG. 6 is a circuit diagram of a first pixel circuit of FIG. 5, according to some example embodiments of the present disclosure.

FIG. 7 is a diagram illustrating that a first pixel circuit of FIG. 5 operates in a global shutter method.

FIG. 8 is a diagram conceptually describing a role of a capacitor shared with a floating diffusion region in a rolling shutter method.

FIG. 9 is a circuit diagram illustrating that a first pixel circuit PIX1 of FIG. 5 operates in a rolling shutter method.

FIG. 10 is a circuit diagram of a first pixel circuit of FIG. 5, according to some example embodiments of the present disclosure.

FIG. 11 is a circuit diagram of a first pixel circuit of FIG. 5, according to some example embodiments of the present disclosure.

FIG. 12 is a circuit diagram of a first pixel circuit of FIG. 5, according to some example embodiments of the present disclosure.

FIG. 13 is a diagram describing a readout of a first pixel circuit of FIG. 12 in a rolling shutter method.

FIG. 14 is a timing diagram describing a readout of a first pixel circuit PIX1 of FIG. 13 in a rolling shutter method.

FIG. 15 is a flowchart describing a method of operating an image sensor, according to some example embodiments of the present disclosure.

### DETAILED DESCRIPTION

Hereinafter, example embodiments of the present disclosure will be described clearly and in detail such that those skilled in the art may easily carry out the present disclosure.

Components described with reference to terms used in the detailed description or claims and functional blocks illustrated in drawings may be implemented with software, hardware, or a combination thereof. For example, the software may be a machine code, firmware, an embedded code, and application software. For example, the hardware may include an electrical circuit, an electronic circuit, a processor, a computer, an integrated circuit, integrated circuit cores, a pressure sensor, an inertial sensor, a passive element, or a combination thereof.

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

When the terms “about” or “substantially” are used in this specification in connection with a numerical value, it is intended that the associated numerical value includes a manufacturing or operational tolerance (e.g., ±10 %) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10 %) around the stated numerical values or shapes.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

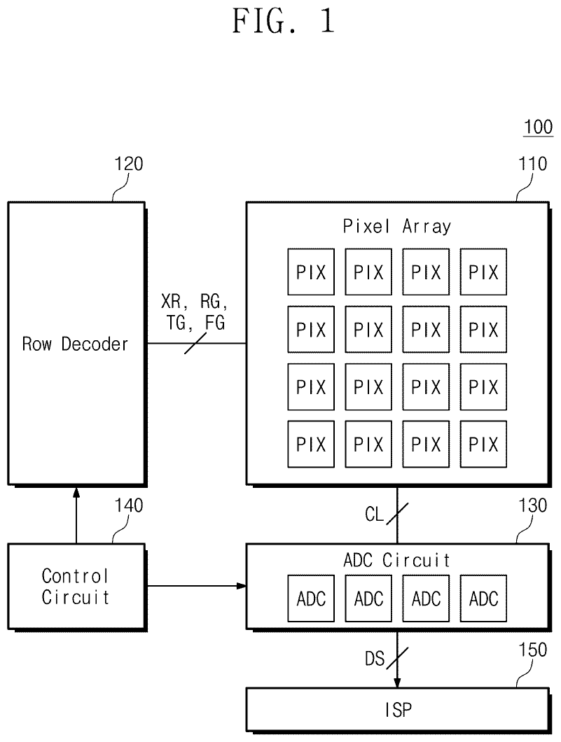

FIG. 1 is a block diagram illustrating an image sensor 100, according to some example embodiments of the present disclosure. Referring to FIG. 1, the image sensor 100 may include a pixel array 110, a row decoder 120, an analog-to-digital converter (ADC) circuit 130, a control circuit 140, and an image signal processor 150.

The pixel array 110 may include a plurality of pixel circuits PIXs and may be in the form of a matrix including a plurality of pixel rows and a plurality of pixel columns. In other words, each of the plurality of pixel circuits PIXs may be arranged in a row direction and a column direction. The pixel circuits located in the same column may be connected to the same column line CL. The pixel circuits located in the same row may be connected to the same reset line. Each of the plurality of pixel circuits PIXs of the pixel array 110 may output a pixel signal depending on the intensity or amount of light received from the outside. In this case, the pixel signal may be an analog signal corresponding to the intensity or amount of light received from the outside. The pixel array 110 of FIG. 1 is illustrated as including 16 pixel circuits PIXs arranged in 4 rows and 4 columns, but the scope of the present disclosure is not limited thereto, and the number of the plurality of pixel circuits PIXs may be less or more than the above, and the arrangement structure may also be different from the above.

The pixel circuit PIX according to some example embodiments of the present disclosure may operate in a hybrid shutter method. The pixel circuit PIX may operate in a shutter method optimized in terms of performance and power consumption of the image sensor 100 depending on an operation mode required for the image sensor 100. For example, when high-resolution photography is required using the image sensor 100, the pixel circuit PIX may operate in a rolling shutter method, and when video recording is performed, the pixel circuit PIX may operate in a global shutter method.

The structure and operation of the pixel circuit PIX will be described in detail through the drawings described below.

The row decoder 120 may provide pixel driving signals such as a row selection signal XR, a reset signal RS, a transmission signal TG, and a floating control signal FG to the pixel array 110. The row decoder 120 may select one row of the pixel array 110 under the control of the control circuit 140. The row decoder 120 may generate the row selection signal XR to select one row among a plurality of rows. In addition, the row decoder 120 may activate the reset signal RS, the transmission signal TG, and the floating control signal FG with respect to the pixel circuit PIX corresponding to the selected row in a predetermined (or, alternatively, desired or selected) order. Thereafter, a reset level signal and a sensing level signal generated from the pixel circuit PIX of the selected row may be provided to the analog-to-digital converter circuit 130.

The analog-to-digital converter circuit 130 may convert the reset level signal and the sensing level signal into a digital signal DS so as to output. For example, the analog-to-digital converter circuit 130 may sample the reset level signal and the sensing level signal in a correlated double sampling (CDS) method and may convert the sampled signals into the digital signal DS. To this end, the analog-to-digital converter circuit 130 may further include a correlated double sampler (not illustrated). The analog-to-digital converter circuit 130 may further include an output buffer circuit (not illustrated) that latches and outputs the digital signal DS. The output buffer circuit may temporarily store the converted digital signal DS and may output the digital signal DS in response to the control of the control circuit 140.

The control circuit 140 may control the pixel array 110, the row decoder 120, the analog-to-digital converter circuit 130, etc. The control circuit 140 may include a timing controller (not illustrated). The timing controller may supply control signals such as a clock signal, a timing control signal, etc. for the operation of the pixel array 110, the row decoder 120, the analog-to-digital converter circuit 130, etc. The control circuit 140 may include a logic control circuit, a phase lock loop circuit, a timing control circuit, and a communication interface circuit.

The image sensor 100 according to some example embodiments of the present disclosure may share one storage area in the pixel circuit PIX in the global shutter method and the rolling shutter method, thereby reducing the area of the pixel circuit PIX while maintaining performance, or improving performance in the same area. A more detailed description thereof will be described later. For example, according to some example embodiments, there may be an increase in reliability, operating parameters, speed, accuracy, and/or power efficiency of the image sensor based on the above methods. Therefore, the improved devices and methods overcome the deficiencies of the conventional devices and methods while reducing resource consumption, and/or improving image accuracy, operating parameters, and resource allocation (e.g., latency).

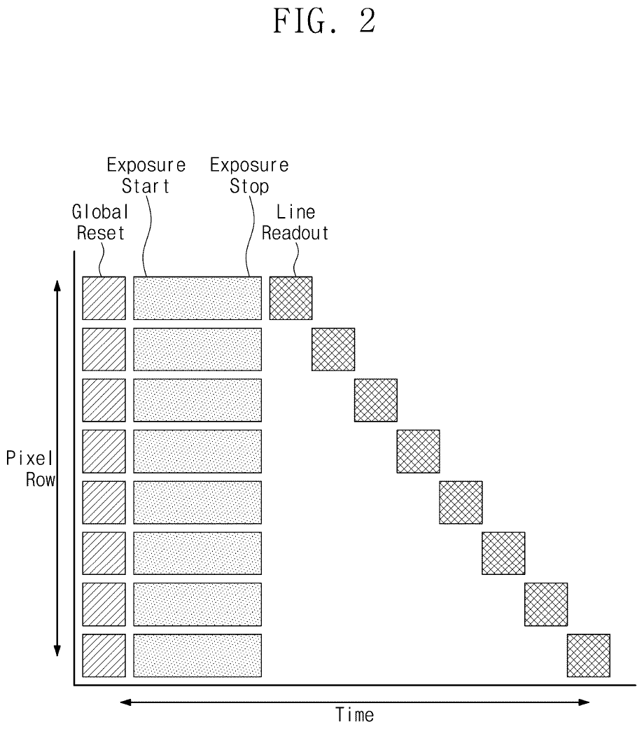

FIG. 2 is a diagram illustrating a global shutter method. Referring to FIG. 2, the global shutter method is conceptually illustrated.

In the global shutter method, signals photoelectrically converted by the photoelectric elements of each of the pixel circuits (hereinafter, target pixel circuits) within a target area are simultaneously (e.g., at or about at the same time) transferred to the floating diffusion node, and then the digital signal of the corresponding pixel may be output from the sequentially selected row.

In detail, in the global shutter method, the image sensor may simultaneously (e.g., at or about at the same time) reset the target pixel circuits, and then simultaneously (e.g., at or about at the same time) transfer the charge corresponding to the light received by photodiodes during the same time period to the floating diffusion node. Thereafter, the pixel signals of the target pixel circuits may be sequentially read out according to the sequentially selected row.

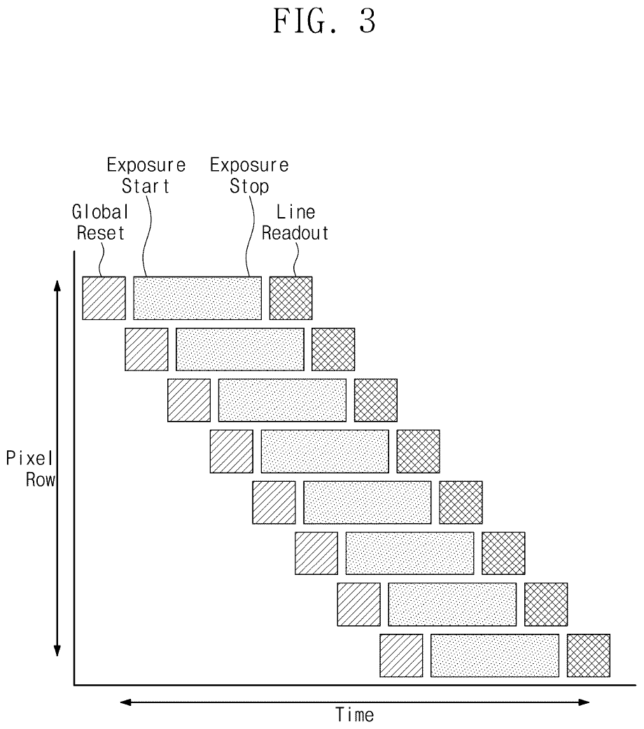

FIG. 3 is a diagram illustrating a rolling shutter method. Referring to FIG. 3, the rolling shutter method is conceptually illustrated.

In the rolling shutter method, unlike the global shutter method of FIG. 2, the image sensor may sequentially perform a reset and a readout for the target pixel circuits in units of rows.

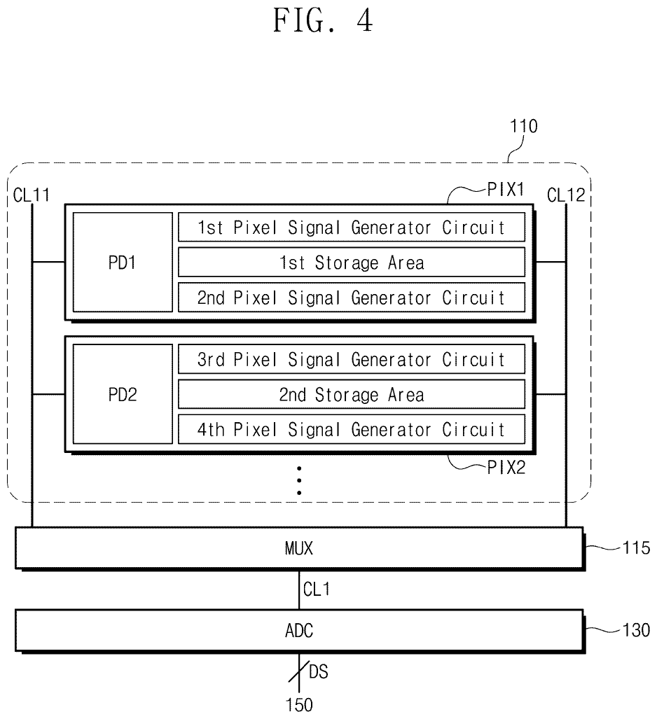

FIG. 4 is a diagram illustrating an image sensor, according to some example embodiments of the present disclosure. Referring to FIG. 4, the pixel array 110 includes a first pixel circuit PIX1, a second pixel circuit PIX2, and the image sensor 100 of FIG. 1 may further include a multiplexer (MUX) 115.

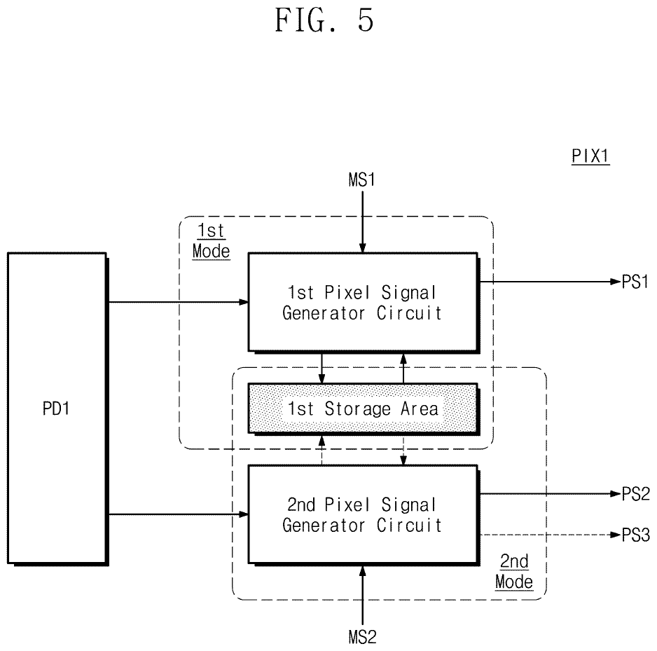

The first pixel circuit PIX1 and the second pixel circuit PIX2 may be arranged in the same column. The first pixel circuit PIX1 may include a first photodiode PD1, a first pixel signal generator circuit, a first storage area, and a second pixel signal generator circuit. The first pixel signal generator circuit may be at least partially associated with the global shutter method. The first storage area may include at least one capacitor. The second pixel signal generator circuit may be at least partially associated with the rolling shutter method. A more detailed description of this will be described later with reference to FIG. 5.

The second pixel circuit PIX2 may include a second photodiode PD2, a third pixel signal generator circuit, a second storage area, and a fourth pixel signal generator circuit. The third pixel signal generator circuit, the second storage area, and the fourth pixel signal generator circuit may correspond to the first pixel signal generator circuit, the first storage area, and the second pixel signal generator circuit of the first pixel circuit PIX1, respectively.

The first pixel signal generator circuit and the third pixel signal generator circuit may be connected to the multiplexer 115 through a first column line CL11. The second pixel signal generator circuit and the fourth pixel signal generator circuit may be connected to the multiplexer 115 through the second column line CL12.

The multiplexer 115 may be connected to the analog-to-digital converter circuit 130 through a first integrated column line CL1. The multiplexer 115 may multiplex the pixel signals received from the first column line CL11 and the second column line CL12 so as to provide to the analog-to-digital converter circuit 130 through the first integrated column line CL1.

The analog-to-digital converter circuit 130 may convert the pixel signals received from the multiplexer 115 into the digital signals DS, respectively. The analog-to-digital converter circuit 130 may provide the converted digital signals DS to the image signal processor 150 of FIG. 1.

FIG. 5 is a detail block diagram of the first pixel circuit PIX1 of FIG. 4. Referring to FIG. 5, the first pixel circuit PIX1 may include the first photodiode PD1, a first pixel signal generator circuit, a first storage area, and a second pixel signal generator circuit.

The first photodiode PD1 may receive light and may generate a charge corresponding to the intensity or the amount of the received light.

The first storage area may include at least one capacitor. For example, the first storage area may include a first capacitor and a second capacitor.

The first pixel signal generator circuit may perform the following operations based on a first mode signal MS1. The first pixel signal generator circuit may store the charge of the first photodiode PD1 (e.g., the charge overflowing from the first photodiode PD1) in the first storage area. Thereafter, the first pixel signal generator circuit may convert the voltage corresponding to the charge stored in the first storage area into a first pixel signal PS1.

In some example embodiments, the first pixel signal generator circuit may store the charge corresponding to the reset level signal among the charges of the first photodiode PD1 in the first capacitor, and may store the charge corresponding to the sensing level signal in the second capacitor. In this case, the reset level signal and the sensing level signal may each represent a sampled signal for use in a correlated double sampling method.

In some example embodiments, the first mode signal MS1 may correspond to the global shutter method. For example, the first mode signal MS1 may correspond to a gating signal of at least one of transistors of the first pixel circuit PIX1.

In some example embodiments, the first pixel signal generator circuit may convert a voltage corresponding to the charge stored in the first capacitor into a reset level signal of the first pixel signal PS1. In addition, the first pixel signal generator circuit may convert a voltage corresponding to the charge stored in the second capacitor into a sensing level signal of the first pixel signal PS1.

The second pixel signal generator circuit may perform the following operations based on a second mode signal MS2. The second pixel signal generator circuit may transfer a charge of the first photodiode PD1 to a storage area. In detail, the second pixel signal generator circuit may transfer a charge overflowing from the first photodiode PD1 to a floating diffusion region and a storage area.

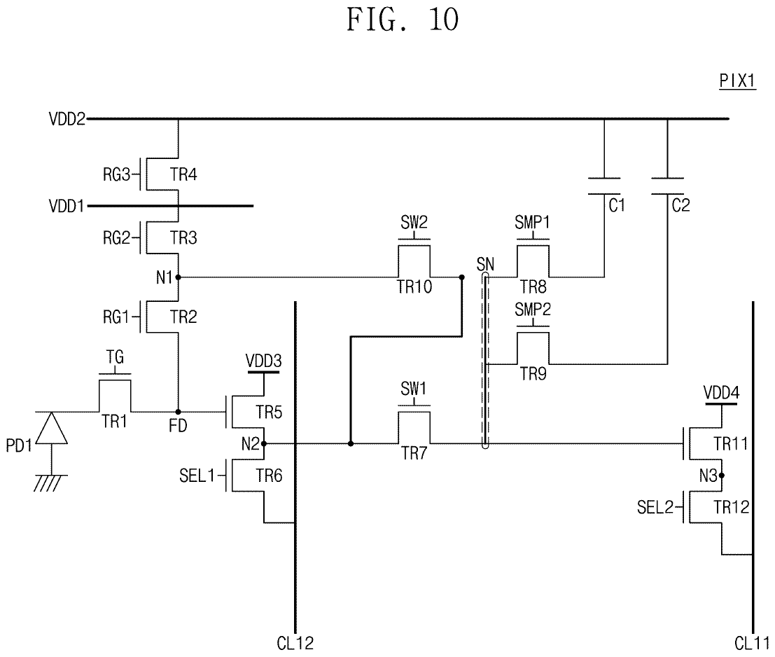

In some example embodiments, the second pixel signal generator circuit may form a charge transfer path between the floating diffusion region and the storage area. A more detailed description thereof will be described later with reference to FIGS. 5 and 10. The first storage area may be used as an expanded electrostatic capacitance of the floating diffusion region.

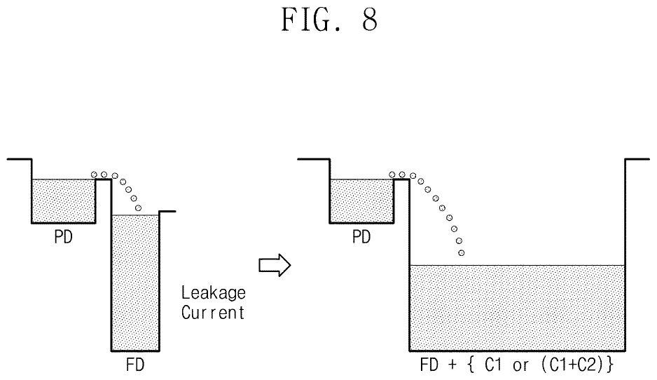

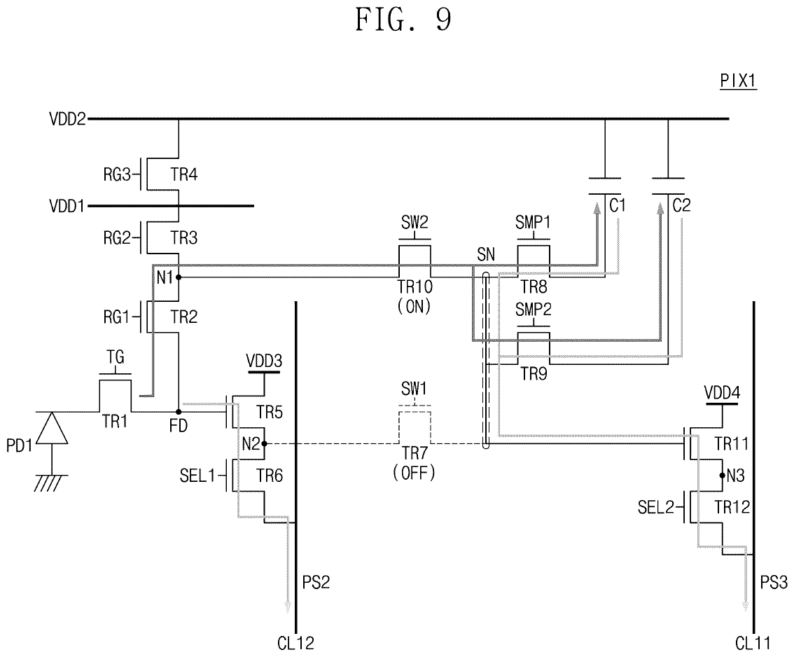

For example, the first storage area may include a first capacitor and a second capacitor. In this case, the charge overflowing from the first photodiode PD1 may be transferred to the expanded floating diffusion region (the floating diffusion region and the first storage area). A more detailed description thereof will be described later with reference to FIGS. 8 and 9.

The second pixel signal generator circuit may convert a voltage corresponding to the charge of the floating diffusion region into a second pixel signal PS2. The second pixel signal generator circuit may convert a voltage corresponding to the charge of the first storage area into a third pixel signal PS3.

In some example embodiments, the first storage area may include a first capacitor and a second capacitor. The second pixel signal generator circuit may store the charge overflowing from the first photodiode PD1 in at least one of the floating diffusion region, the first capacitor, and the second capacitor.

In some example embodiments, the second mode signal MS2 may correspond to the rolling shutter method. For example, the second mode signal MS2 may correspond to a gating signal of at least one transistor of the first pixel circuit PIX1.

The second pixel signal generator circuit may have a floating diffusion region with an expanded electrostatic capacitance by using the first capacitor and the second capacitor. Accordingly, the performance of the image sensor operating in the rolling shutter method may be improved.

In some example embodiments, the first mode signal MS1 and the second mode signal MS2 may be activated at different times from each other. For example, the image sensor may activate the first mode signal MS1 during a first time period and may activate the second mode signal MS2 during a second time period that does not overlap with the first time period.

The first pixel signal generator circuit may be connected to the first column line CL11 of FIG. 4. The first pixel signal generator circuit may output the first pixel signal PS1 through the first column line CL11.

The second pixel signal generator circuit may be connected to the second column line CL12 of FIG. 4. The second pixel signal generator circuit may output the second pixel signal PS2 and the third pixel signal PS3 through the second column line CL12.

In some example embodiments, the analog-to-digital converter circuit 130 of FIG. 1 may convert the first pixel signal PS1, the second pixel signal PS2, and the third pixel signal PS3 into a first digital signal, a second digital signal, and a third digital signal, respectively.

For example, in the rolling shutter method, the image signal processor 150 of FIG. 1 may generate an image signal corresponding to the first pixel circuit PIX1 based on the signal processing operation of the second digital signal and the third digital signal. In this case, an image signal with reduced noise may be generated..

The first pixel signal generator circuit, the first storage area, and the second pixel signal generator circuit are illustrated as separate components with reference to FIG. 5, but the scope of the present disclosure is not limited thereto. The first pixel signal generator circuit may include the first storage area and/or the second pixel signal generator circuit. Alternatively, the second pixel signal generator circuit may include the first pixel signal generator circuit and/or the first storage area.

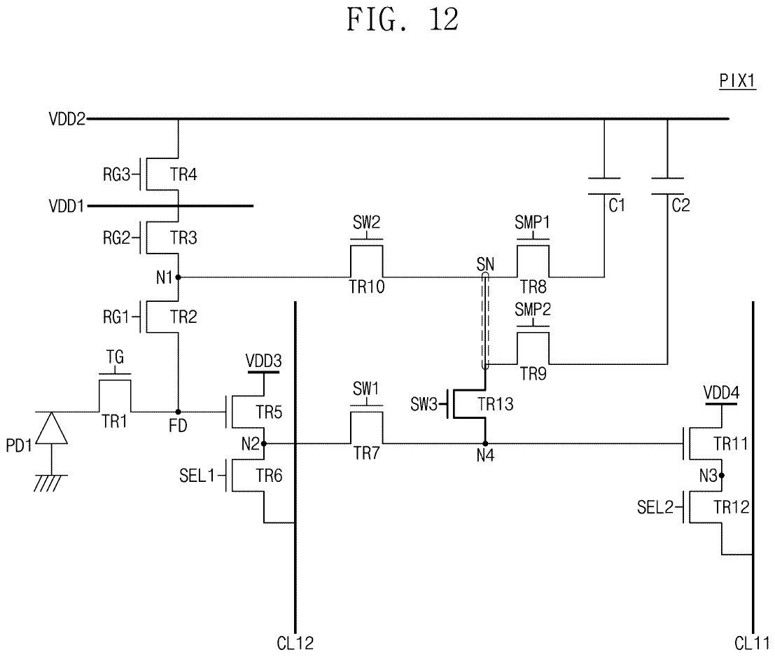

In some example embodiments, the first pixel signal generator circuit may generate the third pixel signal PS3 based on the second mode signal MS2, and may output the third pixel signal PS3 through the first column line CL11. A more detailed description of this will be described later with reference to FIGS. 12 to 14.

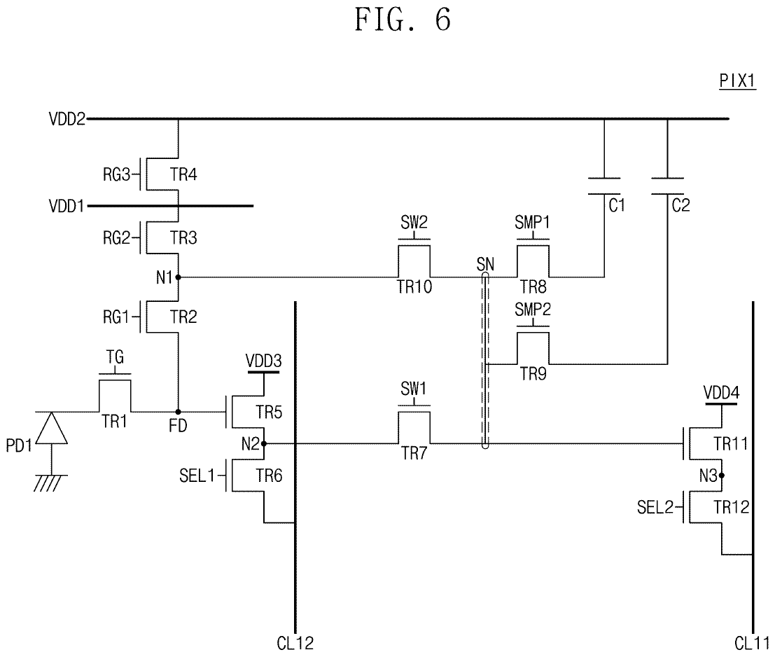

FIG. 6 is a circuit diagram of the first pixel circuit PIX1 of FIG. 5, according to some example embodiments of the present disclosure. Referring to FIG. 6, a detail circuit diagram of the first pixel circuit PIX1 is illustrated.

The first pixel circuit PIX1 may include transistors TR1 to TR12, a first capacitor C1, and a second capacitor C2.

The first transistor TR1 may be connected between the first photodiode PD1 and a floating diffusion node FD and may include a gate that receives the transmission signal TG.

The second transistor TR2 may be connected between a first node N1 and the floating diffusion node FD and may include a gate that receives a first reset signal RS1.

The third transistor TR3 may be connected between the first node N1 and a first power terminal and may include a gate that receives a second reset signal RS2. In this case, the first power terminal may receive a first power supply voltage VDD1.

The fourth transistor TR4 may be connected between the first power terminal and a second power terminal and may include a gate that receives a third reset signal RS3. In this case, the second power terminal may receive a second power supply voltage VDD2. The fourth transistor TR4 may perform a function of resetting the first capacitor C1 and the second capacitor C2 when the first pixel circuit PIX1 operates in the rolling shutter method based on the second mode signal MS2.

The fifth transistor TR5 may be connected between a third power terminal and a second node N2 and may include a gate that is connected to the floating diffusion node FD. In this case, the third power terminal may receive a third power supply voltage VDD3. The fifth transistor TR5 may perform a function as a source follower that outputs a voltage of the floating diffusion node FD. The fifth transistor TR5 may also be referred to as a first source follower transistor.

The sixth transistor TR6 may be connected between the second node N2 and the second column line CL12 and may include a gate that receives a first selection signal SEL1. When the sixth transistor TR6 performs a readout operation, the voltage of the first node N1 may be transferred to the second column line CL12. In addition, the sixth transistor TR6 may perform an on/off function with respect to the second column line CL12. For example, when 0V is input to the gate of the sixth transistor TR6, the second column line CL12 may be turned off.

The seventh transistor TR7 may be connected between the second node N2 and a storage node SN and may include a gate that receives a first switch signal SW1.

The eighth transistor TR8 may be connected between the storage node SN and one end of the first capacitor C1 and may include a gate that receives a first sampling signal SMP1.

The ninth transistor TR9 may be connected between the storage node SN and one end of the second capacitor C2 and may include a gate that receives a second sampling signal SMP2.

The tenth transistor TR10 may be connected between the first node N1 and the storage node SN and may include a gate that receives a second switch signal SW2.

The eleventh transistor TR11 may be connected between the fourth power terminal and a third node N3 and may include a gate that is connected to the storage node SN. In this case, the fourth power terminal may receive a fourth power supply voltage VDD4. The eleventh transistor TR11 may perform a function as a source follower that outputs the voltage of the storage node SN. The eleventh transistor TR11 may also be referred to as a second source follower transistor.

The twelfth transistor TR12 may be connected between the third node N3 and the first column line CL11 and may include a gate that receives the second selection signal SEL2. When the twelfth transistor TR12 performs a readout operation, the voltage of the third node N3 may be transferred to the first column line CL11. In addition, the twelfth transistor TR12 may perform an on/off function with respect to the first column line CL11. For example, when 0V is input to the gate of the twelfth transistor TR12, the first column line CL11 may be turned off.

The other terminal of the first capacitor C1 may be connected to the second power terminal. The other terminal of the second capacitor C2 may be connected to the second power terminal. In other words, the first capacitor C1 and the second capacitor C2 may be connected in parallel between the storage node SN and the second power terminal while the eighth transistor TR8 and the ninth transistor TR9 are turned on.

For convenience of description, although not illustrated, the first pixel circuit PIX1 may further include at least one transistor (also referred to as a precharge transistor) associated with a precharge between the second node N2 and a ground power, or between the storage node SN and the ground power. The precharge transistor may perform a biasing role in a dump operation. For example, in the global shutter mode, the image sensor may store the voltage of the second node N2 in the first capacitor C1 or the second capacitor C2 by the dump operation.

Each of the gating signals of the transistors TR1 to TR12 may be controlled according to a sequence determined by a mode signal.

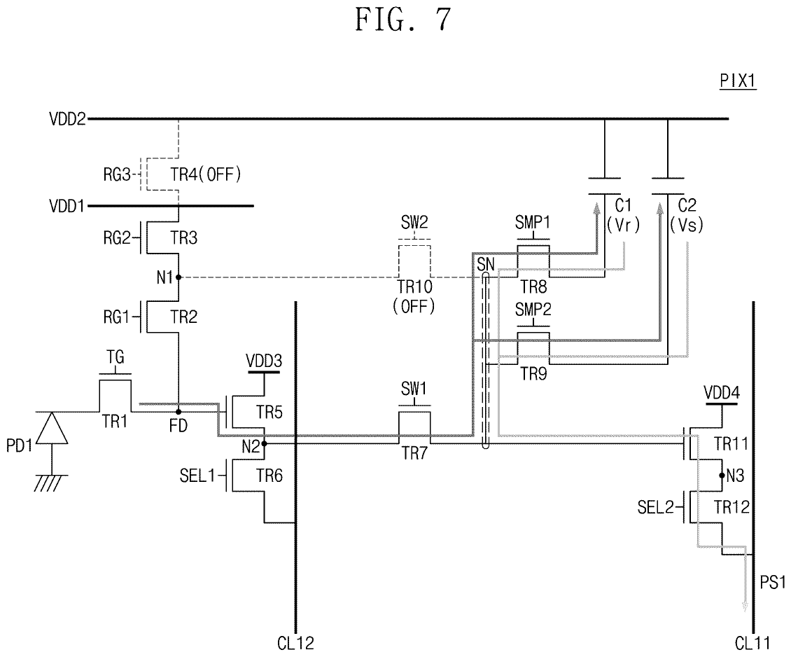

FIG. 7 is a diagram illustrating that the first pixel circuit PIX1 of FIG. 5 operates in a global shutter method. Referring to FIG. 7, a circuit diagram of the first pixel circuit PIX1 operating in the global shutter method is illustrated. The components of FIG. 7 may correspond to the components of FIG. 6 having the same reference symbols, respectively.

The first pixel circuit PIX1 may turn off the fourth transistor TR4 and the tenth transistor TR10 based on the first mode signal.

In this case, the precharge transistor (not illustrated) may maintain the biasing of the first pixel circuit PIX1 to dump the charge of the floating diffusion node FD to the first capacitor C1 and the second capacitor C2.

The first pixel circuit PIX1 may store a charge corresponding to a global reset voltage Vr in the first capacitor C1 and may store a charge corresponding to a global pixel voltage Vs in the second capacitor C2.

Thereafter, the readout operation may be performed while the eighth transistor TR8 and the ninth transistor TR9 are sequentially turned on again. In detail, when the eighth transistor TR8 is turned on, the global reset voltage Vr stored in the first capacitor C1 is transferred to the storage node SN. When the ninth transistor TR9 is turned on, the global pixel voltage Vs stored in the second capacitor C2 is transferred to the storage node SN. The eleventh transistor TR11 may sequentially amplify the global reset voltage Vr and the global pixel voltage Vs of the storage node SN, and may output the amplified voltages as the first pixel signal PS1 through the twelfth transistor TR12 that is turned on.

The first pixel circuit PIX1 may output the first pixel signal PS1 through the first column line CL11.

FIG. 8 is a diagram conceptually describing a role of a capacitor shared with a floating diffusion region FD in a rolling shutter method. Referring to FIG. 8, the flow of charge is described when there is the capacitor C1 or C2 shared with the floating diffusion region FD and when there is no capacitor.

A photodiode PD may have a higher potential level than the floating diffusion region FD. Therefore, the photodiode PD of FIG. 6 generates charges corresponding to the received light, and some of the charges generated by the photodiode PD overflows and are transferred to the floating diffusion region FD.

In this case, when the intensity or the amount of light received by the photodiode PD increases, the charge transferred from the photodiode PD may be greater than the electrostatic capacitance of the floating diffusion region FD. The charge overflowing from the floating diffusion region FD may cause noise as a leakage current, thereby degrading the performance of the image sensor.

In contrast, when there is the capacitor C1 or C2 electrically connected (or shared) with the floating diffusion region FD, the capacitance of the floating diffusion region FD may be expanded. In detail, the charge overflowing from the photodiode PD may be transferred to the floating diffusion region FD, the first capacitor C1, and the second capacitor C2.

In other words, the charge overflowing from the photodiode PD may be transferred to the expanded floating diffusion region having the capacitance that is the sum of the capacitances of each of the floating diffusion region FD, the first capacitor C1, and the second capacitor C2. Therefore, the leakage current due to the charge overflowing from the photodiode PD may be eliminated or reduced.

In this case, not only the charge of the floating diffusion region FD that is not transferred to the capacitors C1 and C2, but also the charge of the floating diffusion region FD that is transferred to the capacitors C1 and C2 may be read out and used to generate an image signal, so that noise or distortion of the image signal may be reduced.

FIG. 9 is a circuit diagram illustrating that the first pixel circuit PIX1 of FIG. 5 operates in a rolling shutter method. Referring to FIG. 9, in the rolling shutter method, the flow of charge transferred from the first pixel circuit PIX1 to the floating diffusion node FD and the readout operation may be described. The components of FIG. 9 may respectively correspond to the components having the same reference symbols in FIG. 6.

Based on the second mode signal, the first pixel circuit PIX1 may operate as follows.

First, the seventh transistor TR7 may be turned off by the first switch signal SW1, and the tenth transistor TR10 may be turned on by the second switch signal SW2. In addition, at least one of the eighth transistor TR8 and the ninth transistor TR9 may be turned on by the first sampling signal SMP1 and the second sampling signal SMP2. In other words, a charge transfer path may be formed between at least one of the first capacitor C1 and the second capacitor C2 and the floating diffusion node FD.

The charges overflowing from the first photodiode PD1 may be transferred to the floating diffusion node FD, the first capacitor C1, and the second capacitor C2. In this case, the first capacitor C1 and the second capacitor C2 may be used as the expanded electrostatic capacitance of the floating diffusion node FD. In detail, the first capacitor C1 and the second capacitor C2 may expand the floating diffusion region FD, as described with reference to FIG. 8.

Thereafter, the first pixel circuit PIX1 may perform a readout operation. In detail, the fifth transistor TR5 may amplify the voltage of the floating diffusion node FD. The sixth transistor TR6 that is turned on may output the amplified voltage as the second pixel signal PS2 through the second column line CL12.

The charge stored in the first capacitor C1 may be transferred to the storage node SN by turning on the eighth transistor TR8 again by the first sampling signal SMP1.

The charge stored in the second capacitor C2 may be transferred to the storage node SN by turning on the ninth transistor TR9 again by the second sampling signal SMP2.

The eleventh transistor TR11 may amplify the voltage of the storage node SN. The twelfth transistor TR12 may output the amplified voltage as the third pixel signal PS3 through the first column line CL11 by being turned on by the second selection signal SEL2.

The second pixel signal PS2 and the third pixel signal PS3 are each converted into digital signals by an analog-to-digital converter circuit, and the converted digital signals may be converted into image signals corresponding to the first pixel circuit PIX1 by a signal processing operation in an image signal processor.

The image sensor according to the present disclosure may use a capacitor used when operating in the global shutter method, when operating in the rolling shutter method. Accordingly, the image sensor does not need to have a separate capacitor to improve the performance of the rolling shutter method, e.g., to expand the electrostatic capacitance of the floating diffusion region FD. Accordingly, the performance of the image sensor may be improved in the same area, or the area occupied may be reduced while maintaining the performance of the image sensor.

Furthermore, although not illustrated separately, in some example embodiments, the image sensor according to the present disclosure may turn off the fourth transistor TR4, the seventh transistor TR7, and the tenth transistor TR10 based on the third mode signal. For example, to optimize power consumption, the image sensor may operate in the rolling shutter method that does not use capacitors C1 and C2 that expand the floating diffusion region FD.

FIG. 10 is a circuit diagram of the first pixel circuit PIX1 of FIG. 5, according to some example embodiments of the present disclosure. Referring to FIG. 10, some example embodiments are illustrated in which the tenth transistor TR10 is connected to the second node N2. The remaining components of FIG. 10 may correspond to the components of FIG. 6 having the same reference symbols.

For convenience of description, descriptions overlapping with FIG. 6 are omitted below.

The tenth transistor TR10 may be connected between the first node N1 and the second node N2.

Based on the first mode signal, that is, in the global shutter method, the tenth transistor TR10 may be turned off by the second switch signal SW2, and the fourth transistor TR4 may be turned off by the third reset signal RS3. The charge of the floating diffusion node FD corresponding to the reset voltage may be stored in the first capacitor C1 through the seventh transistor TR7 and the storage node SN. The charge of the floating diffusion node FD corresponding to the pixel voltage may be stored in the second capacitor C2 through the seventh transistor TR7 and the storage node SN.

The readout operation based on the first mode signal may be the same as in FIG. 5. The charge stored in the first capacitor C1 and the charge stored in the second capacitor C2 may be sequentially amplified by the eleventh transistor TR11 and may be output as the first pixel signal to the first column line CL11 through the twelfth transistor TR12.

Based on the second mode signal, that is, in the rolling shutter method, the seventh transistor TR7 may be turned off by the first switch signal SW1 and the tenth transistor TR10 may be turned on by the second switch signal SW2. The fourth transistor TR4 may be turned on by the third reset signal RS3 to reset the first capacitor C1 and the second capacitor C2.

In this case, the charge overflowing from the first photodiode PD1 may be stored in the floating diffusion node FD, the first capacitor C1, and the second capacitor C2. In detail, the first part of the charge overflowing from the first photodiode PD1 may be transferred to the floating diffusion node FD, the second part may be transferred to the first capacitor C1 through the tenth transistor TR10, the seventh transistor TR7, and the storage node SN sequentially, and the third part may be transferred to the second capacitor C2 through the tenth transistor TR10, the seventh transistor TR7, and the storage node SN sequentially.

The readout operation based on the second mode signal may be the same as in FIG. 5. The voltage corresponding to the charge of the floating diffusion region FD may be amplified by the fifth transistor TR5 and may be output as the second pixel signal to the second column line CL12 through the sixth transistor TR6. The voltage corresponding to the charges transferred to the first capacitor C1 and the second capacitor C2 may be amplified by the eleventh transistor TR11 and may be output as the third pixel signal to the first column line CL11 through the twelfth transistor TR12.

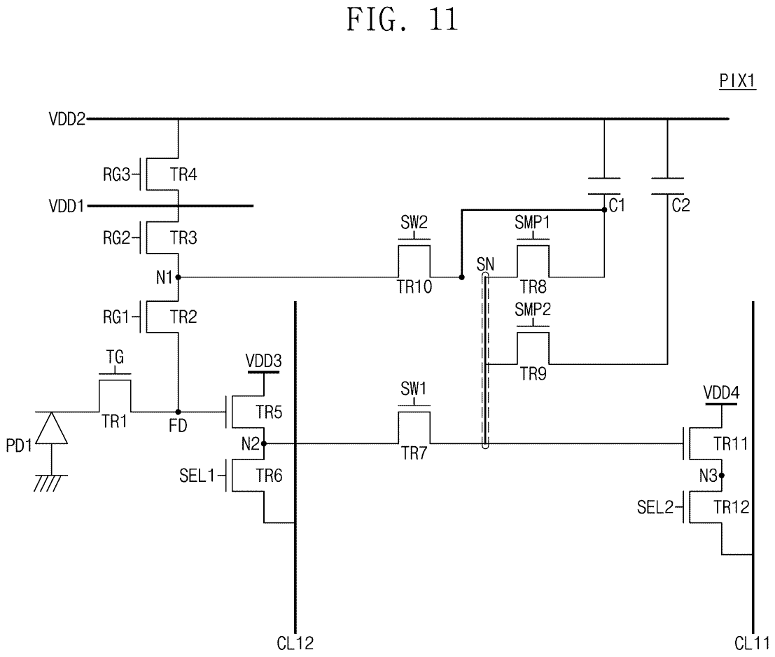

FIG. 11 is a circuit diagram of the first pixel circuit PIX1 of FIG. 5, according to some example embodiments of the present disclosure. Referring to FIG. 11, some example embodiments are illustrated in which the tenth transistor TR10 is connected to one end of the first capacitor C1. The remaining components of FIG. 11 may correspond to the components of FIG. 6 having the same reference symbols.

For convenience of description, descriptions overlapping with FIG. 6 are omitted below.

The tenth transistor TR10 may be connected to the first node N1 and one end of one of the first capacitor C1 and the second capacitor C2. Hereinafter, some example embodiments in which the tenth transistor TR10 is connected to the first node N1 and one end of the first capacitor C1 will be described.

Based on the first mode signal, that is, in the global shutter method, the charge of the floating diffusion node FD corresponding to the reset voltage similarly to FIG. 10 may be stored in the first capacitor C1. In addition, the charge of the floating diffusion node FD corresponding to the pixel voltage may be stored in the second capacitor C2.

The readout operation based on the first mode signal may be the same as in FIG. 10.

Based on the second mode signal, that is, in the rolling shutter method, the seventh transistor TR7 may be turned off by the first switch signal SW1 and the tenth transistor TR10 may be turned on by the second switch signal SW2. The fourth transistor TR4 may be turned on to reset the first capacitor C1 by the third reset signal RS3.

In this case, the first part of the charges overflowing from the first photodiode PD1 may be transferred to the floating diffusion node FD, and the second part may be transferred to the first capacitor C1 through the floating diffusion node FD and the tenth transistor TR10.

The readout operation based on the second mode signal is as follows. The voltage corresponding to the charge of the floating diffusion region FD may be amplified by the fifth transistor TR5 and may be output as the second pixel signal to the second column line CL12 through the sixth transistor TR6.

Furthermore, the voltage corresponding to the charge transferred to the first capacitor C1 may be amplified by the eleventh transistor TR11 and may be output as the third pixel signal to the first column line CL11 through the twelfth transistor TR12.

As described above with reference to FIGS. 5, 10, and 11, the tenth transistor TR10, which is turned on/off depending on the first mode signal and the second mode signal, may be connected in various ways within the first pixel circuit PIX1, and the scope of the present disclosure is not limited thereto. All connection relationships of the tenth transistor TR10 that may create a charge flow path between at least one of the first capacitor C1 and the second capacitor C2 and the floating diffusion node FD may be included in the scope of the present disclosure.

Referring to FIGS. 12 to 14, some example embodiments are described in which, in the rolling shutter method, both the second pixel signal PS2 and the third pixel signal PS3 are output through the second column line CL12.

FIG. 12 is a circuit diagram of the first pixel circuit PIX1 of FIG. 5, according to some example embodiments of the present disclosure. Referring to FIG. 12, the first pixel circuit PIX1 further includes a thirteenth transistor TR13 connected between the storage node SN and a fourth node N4, and including a gate that receives a third switch signal SW3. The components of FIG. 12 may respectively correspond to the components of FIG. 6 having the same reference symbols.

For convenience of description, descriptions overlapping with FIG. 6 are omitted below.

The seventh transistor TR7 is connected between the second node N2 and the fourth node N4. A gate terminal of the eleventh transistor TR11 is connected to the fourth node N4. The thirteenth transistor TR13 added in some example embodiments illustrated in FIG. 12 is connected between the storage node SN and the fourth node N4.

When the thirteenth transistor TR13 is turned on by the third switch signal SW3, the first pixel circuit PIX1 of FIG. 12 has the same structure as the first pixel circuit PIX1 of FIG. 6 and may operate in the same manner.

Based on the first mode signal, that is, in the global shutter method, the thirteenth transistor TR13 may be turned on by the third switch signal SW3. Therefore, the reset voltage stored in the first capacitor C1 may be read out through the first column line CL11. In addition, the pixel voltage stored in the second capacitor C2 may be read out through the first column line CL11.

Based on the second mode signal, that is, in the rolling shutter mode, the first pixel circuit PIX1 may operate as follows. The seventh transistor TR7 may be turned off, and the tenth transistor TR10 may be turned on. A first part of the charge overflowing from the first photodiode PD1 may be transferred to the floating diffusion node FD, a second part may be transferred to the first capacitor C1 through the floating diffusion node FD, the tenth transistor TR10, and the storage node SN, and a third part may be transferred to the second capacitor C2 through the floating diffusion node FD, the tenth transistor TR10, and the storage node SN.

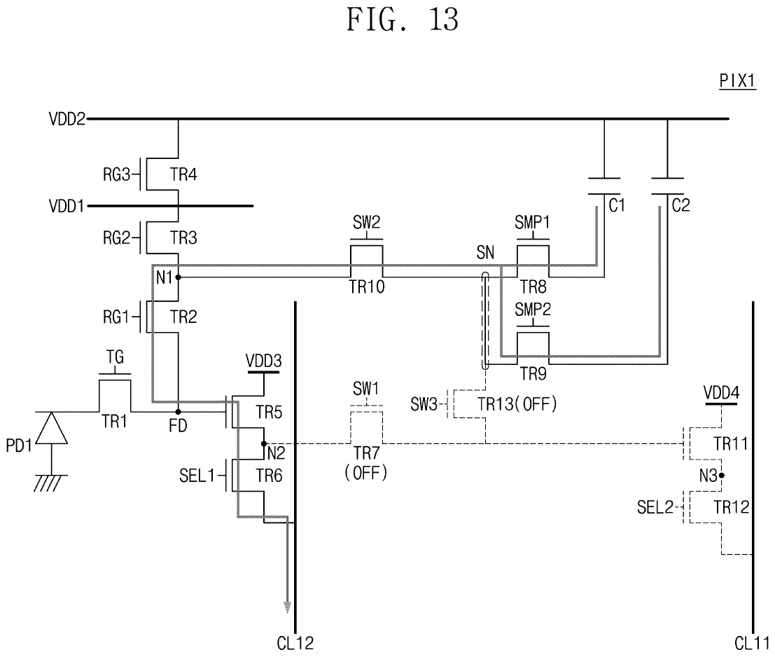

In a readout operation based on the second mode signal, the thirteenth transistor TR13 may be turned off to output the third pixel signal to the second column line CL12. This will be described in detail with reference to FIG. 13 below.

FIG. 13 is a diagram describing the readout of the first pixel circuit PIX1 of FIG. 12 in the rolling shutter method. Referring to FIG. 13, a readout path in the rolling shutter method is described in a state where the thirteenth transistor TR13 is turned off by the third switch signal SW3.

For convenience of description, descriptions overlapping with FIG. 12 are omitted below.

In a readout operation based on the second mode signal, e.g., the rolling shutter method readout, the thirteenth transistor TR13 may be turned off by the third switch signal SW3.

First, in a state where the second transistor TR2 is turned off by the first reset signal RS1, a voltage corresponding to the charge of the floating diffusion node FD may be amplified by the fifth transistor TR5 and may be output as the second pixel signal PS2 to the second column line CL12 through the sixth transistor TR6.

Next, first, the second transistor TR2 may be turned on by the first reset signal RS1, the eighth transistor TR8 may be turned on again by the first sampling signal SMP1, and the ninth transistor TR9 may be turned on again by the second sampling signal SMP2. In this state, the charges stored in the first capacitor C1 and the second capacitor C2 are transferred to the floating diffusion region FD through the storage node SN and the second transistor TR2 (since the thirteenth transistor TR13 is turned off, the voltage of the storage node SN may not be amplified by the eleventh transistor TR11).

The voltage corresponding to the charge corresponding to the first capacitor C1 and the second capacitor C2 (e.g., the charge stored in the first capacitor C1 and the second capacitor C2 and then transferred to the floating diffusion node FD) may be amplified by the fifth transistor TR5. The amplified voltage may be output as the third pixel signal PS3 to the second column line CL12 through the sixth transistor TR6 that is turned on.

Hereinafter, a detail operation sequence regarding the readout operation in which the second pixel signal PS2 and the third pixel signal PS3 described above are sequentially output through the second column line CL12 will be described.

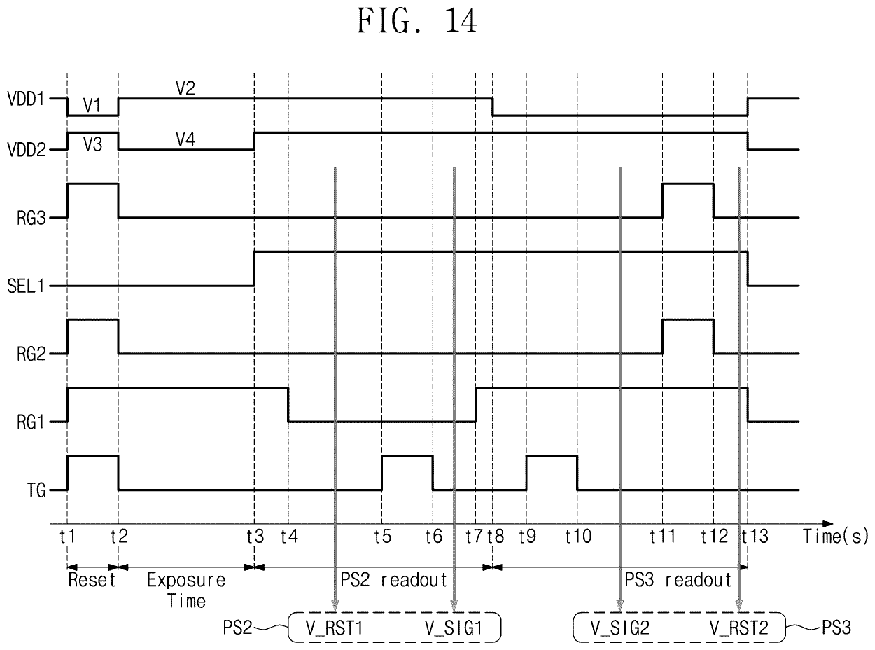

FIG. 14 is a timing diagram describing a readout of a first pixel circuit PIX1 of FIG. 13 in a rolling shutter method. Referring to FIG. 14, a timing diagram is illustrated for describing an operation of sequentially outputting the second pixel signal PS2 and the third pixel signal PS3 through the same column line (e.g., the second column line CL12 of FIG. 13) based on the second mode signal. The signals of FIG. 14 may correspond to the signals of FIG. 13 having the same reference symbol, respectively.

Hereinafter, a readout operation over time will be described with reference to FIG. 13 and FIG. 14.

The first power supply voltage VDD1 may have a first voltage level V1 from a first time t1 to a second time t2 and from an eighth time t8 to a thirteenth time t13. In addition, the first power supply voltage VDD1 may have a second voltage level V2 from the second time t2 to the eighth time t8. The first voltage level V1 may be lower than the second voltage level V2.

The second power supply voltage VDD2 may have a third voltage level V3 from the first time t1 to the second time t2 and from a third time t3 to the thirteenth time t13. In addition, the second power supply voltage VDD2 may have a fourth voltage level V4 from the second time t2 to the third time t3.

The first time t1 to the second time t2 may be referred to as a reset period, the second time t2 to the eighth time t8 may be referred to as a readout period of the second pixel signal PS2, and the eighth time t8 to the thirteenth time t13 may be referred to as a readout period of the third pixel signal PS3.

From the first time t1 to the second time t2, the transmission signal TG, the first reset signal RS1, the second reset signal RS2, and the third reset signal RS3 may be at a high level. Accordingly, the second transistor TR2, the third transistor TR3, and the fourth transistor TR4 may be turned on at the first time t1 and may be turned off at the second time t2. Accordingly, the first pixel circuit PIX1 may be reset.

From the second time t2 to the third time t3, the first photodiode PD1 may receive light and may convert the received light into corresponding charges. In this case, the charge generated in the first photodiode PD1 may be transferred to the floating diffusion node FD, the first capacitor C1, and the second capacitor C2 (e.g., similar to the expanded floating diffusion region of FIG. 8). The charge of the photodiode PD may be transferred to at least one of the first capacitor C1 and the second capacitor C2, and the capacitor to which the charge is transferred may be determined depending on the first sampling signal SMP1 and the second sampling signal SMP2.

At the third time t3, the first selection signal SEL1 may change from a low level to a high level. While the first selection signal SEL1 has a high level, the sixth transistor TR6 may be turned on. In this case, the second column line CL12 may be turned on.

From the second time t2 to the fourth time t4, since the first reset signal RS1 has a high level, the second transistor TR2 may be turned on. At the fourth time t4, the first reset signal RS1 may change from a high level to a low level. Accordingly, the second transistor TR2 may be turned off.

Between the fourth time t4 when the second transistor TR2 is turned off and the fifth time t5 when the transmission signal TG changes from a low level to a high level, the first pixel circuit PIX1 may output a first reset voltage V_RST1 of the second pixel signal PS2 corresponding to the voltage of the floating diffusion region FD through the second column line CL12.

In some example embodiments, the first pixel circuit PIX1 may read out the first reset voltage V_RST1 after a predetermined (or, alternatively, desired or selected) time elapses from the fourth time t4 when the second transistor TR2 is turned off. For example, the predetermined (or, alternatively, desired or selected) time may be a circuit stabilization time.

From the fifth time t5 to the sixth time t6, the transmission signal TG may have a high level.

At the sixth time t6, the transmission signal TG may change from a high level to a low level. In this case, the first transistor TR1 may be turned off.

Between the sixth time t6 and the seventh time t7, a first pixel voltage V_SIG1 of the second pixel signal PS2 corresponding to the voltage of the floating diffusion node FD may be output through the second column line CL12.

At the seventh time t7, the first reset signal RS1 may change from a low level to a high level. In this case, the second transistor TR2 may be turned on. In this case, the floating diffusion node FD may be electrically connected to the first capacitor C1 or the second capacitor C2 (e.g., a path through which charges may transfer may be formed). The first reset signal RS1 may have a high level from the seventh time t7 to the thirteenth time t13, and accordingly, the second transistor TR2 may also maintain a turn-on state.

At the ninth time t9, the transmission signal TG may change from a low level to a high level. From the ninth time t9 to the tenth time t10, the transmission signal TG may have a high level. At the tenth time t10, the transmission signal TG may change from a high level to a low level. Accordingly, the first transistor TR1 may be turned on at the ninth time t9 and then turned off at the tenth time t10.

Between the tenth time t10 and the eleventh time t11, the first pixel circuit PIX1 may read out a voltage corresponding to the charges transferred to the expanded floating diffusion region (e.g., the charges transferred to the floating diffusion region FD, the first capacitor C1, and the second capacitor C2) as a second pixel voltage V_SIG2 of the third pixel signal PS3. In addition, since the first selection signal SEL1 has a high level, the first pixel circuit PIX1 may output the second pixel voltage V_SIG2 through the second column line CL12.

In some example embodiments, the first pixel circuit PIX1 may read out the second pixel voltage V_SIG2 after a predetermined (or, alternatively, desired or selected) time elapses from the tenth time t10 when the first transistor TR1 is turned off. For example, the predetermined (or, alternatively, desired or selected) time may be a circuit stabilization time.

At the eleventh time t11, the second reset signal RS2 and the third reset signal RS3 may change from a low level to a high level. From the eleventh time t11 to the twelfth time t12, the second reset signal RS2 and the third reset signal RS3 may each have a high level. At the twelfth time t12, the second reset signal RS2 and the third reset signal RS3 may change from a high level to a low level. Accordingly, the third transistor TR3 and the fourth transistor TR4 may be turned on at the eleventh time t11 and may be turned off at the twelfth time t12. That is, the first capacitor C1 and the second capacitor C2 may be reset.

Between the twelfth time t12 and the thirteenth time t13, the first pixel circuit PIX1 may read out the voltage of the floating diffusion node FD as a second reset voltage V_RST2 of the third pixel signal PS3. In this case, since the first selection signal SEL1 has a high level, the first pixel circuit PIX1 may output the second reset voltage V_RST2 through the second column line CL12.

In some example embodiments, during the time period in which the first photodiode PD1 receives light, the second power supply voltage VDD2 may have the fourth voltage level V4 lower than the third voltage level V3 such that leakage current does not occur in the peripheral elements of the second power terminal.

In some example embodiments, from the first time t1 to the second time t2 and from the eleventh time t11 to the twelfth time t12, the third reset signal RS3 has a high level, so that the fourth transistor TR4 may be turned on. In this case, the first voltage level V1 may be the same as the third voltage level V3.

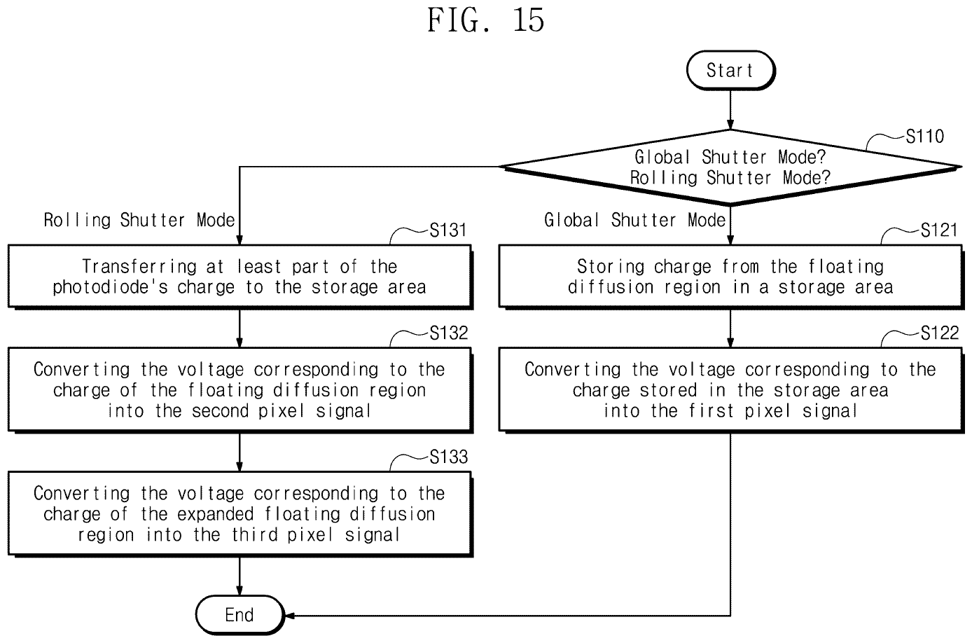

FIG. 15 is a flowchart describing a method of operating an image sensor, according to some example embodiments of the present disclosure. Referring to FIG. 15, a method of operating an image sensor will be described. The image sensor may correspond to the image sensor 100 of FIG. 1.

In operation S110, the image sensor may determine whether to operate in a global shutter method or a rolling shutter method. When the image sensor determines to operate in the global shutter method, the image sensor may proceed to operation S121. In contrast, when the image sensor determines to operate in the rolling shutter method, the image sensor may proceed to operation S131.

In some example embodiments, the image sensor may select one of the global shutter method or the rolling shutter method according to a predetermined (or, alternatively, desired or selected) method.

In this case, when the global shutter method is selected, the image sensor may provide a first mode signal to the pixel circuit. The first mode signal may correspond to control signals that cause the pixel circuit to operate in the global shutter method.

In contrast, when the rolling shutter method is selected, the image sensor may provide a second mode signal to the pixel circuit. The second mode signal may correspond to control signals that cause the pixel circuit to operate in the rolling shutter method.

In operation S121, the image sensor may store charges of the floating diffusion region in a storage area.

In some example embodiments, the storage area may include a first capacitor and a second capacitor.

For example, the image sensor may store a charge corresponding to the reset voltage in the first capacitor, and may store a charge corresponding to the pixel voltage in the second capacitor.

In operation S122, the image sensor may convert a voltage corresponding to the charge stored in the storage area into the first pixel signal.

In operation S131, the image sensor may transfer at least some of the charge of the photodiode to the storage area.

In some example embodiments, the charge overflowing from the photodiode may be transferred to the floating diffusion region and the storage area.

In some example embodiments, the storage area may include the first capacitor and the second capacitor, and in operation S131, the image sensor may transfer the charge to at least one of the first capacitor and the second capacitor.

In some example embodiments, the image sensor may use the first capacitor and the second capacitor as an expanded floating diffusion region.

In operation S132, the image sensor may convert a voltage corresponding to the charge of the floating diffusion region into the second pixel signal.

In operation S133, the image sensor may convert a voltage corresponding to a charge of the extended floating diffusion region into the third pixel signal.

In some example embodiments, the image sensor may output the first pixel signal through the first column line and the second pixel signal through the second column line. In this case, the third pixel signal may be output through one of the first column line and the second column line.

In some example embodiments, the image sensor may sequentially output the second pixel signal and the third pixel signal through the second column line.

According to some example embodiments of the present disclosure, an image sensor of a hybrid shutter driving method sharing a storage area is provided.

In addition, since the storage area used to store a signal in a global shutter operation may be used to expand the capacitance of a floating diffusion region in a rolling shutter operation, the image sensor is provided that reduces the size, cost, and power consumption while maintaining performance, or improves the performance of a rolling shutter operation while maintaining the same size.

The above descriptions are detail embodiments for carrying out the present disclosure. Embodiments in which a design is changed simply or which are easily changed may be included in the present disclosure as well as some example embodiments described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. An image sensor comprising:
a first photodiode;
a second photodiode;
a storage area including a first capacitor and a second capacitor;
a first pixel signal generator circuit configured to convert a voltage corresponding to a charge of the first photodiode stored in the storage area into a first pixel signal, based on a first mode signal; and
a second pixel signal generator circuit configured to convert a voltage corresponding to a charge of the first photodiode into a second pixel signal, based on a second mode signal, and
wherein, based on the first mode signal, a pixel signal corresponding to the first photodiode and a pixel signal corresponding to the second photodiode are simultaneously read out,
wherein, based on the second mode signal, the pixel signal corresponding to the first photodiode and the pixel signal corresponding to the second photodiode are sequentially read out, and
wherein the first pixel signal generator circuit is configured to transfer at least a part of the charge of the first photodiode to the storage area based on the second mode signal.

2. The image sensor of claim 1, wherein, based on the second mode signal, the first pixel signal generator circuit is configured to form a charge transfer path between at least one of the first capacitor and the second capacitor and a floating diffusion region, and use the storage area as an expanded electrostatic capacitance of the floating diffusion region.

3. The image sensor of claim 1, wherein, based on the second mode signal, the second pixel signal generator circuit is configured to convert a voltage corresponding to a charge of a floating diffusion region into the second pixel signal, and
wherein, based on the second mode signal, the first pixel signal generator circuit is configured to convert a voltage corresponding to a charge of the storage area into a third pixel signal.

4. The image sensor of claim 3, further comprising:
an analog-to-digital converter circuit configured to convert the first pixel signal, the second pixel signal, and the third pixel signal into a first digital signal, a second digital signal, and a third digital signal, respectively;
a first column line connected to the first pixel signal generator circuit; and
a second column line connected to the second pixel signal generator circuit, and
wherein the first pixel signal generator circuit is configured to output the third pixel signal through the first column line to the analog-to-digital converter circuit, and
wherein the second pixel signal generator circuit is configured to output the second pixel signal through the second column line to the analog-to-digital converter circuit.

5. The image sensor of claim 3, further comprising:
an analog-to-digital converter circuit configured to convert the second pixel signal and the third pixel signal into a second digital signal and a third digital signal, respectively; and
an image signal processor configured to generate an image signal corresponding to the first photodiode based on a signal processing operation of the second digital signal and the third digital signal.

6. The image sensor of claim 1, wherein, based on the second mode signal, the second pixel signal generator circuit is configured to:
during a first time period, convert a voltage corresponding to a charge of a floating diffusion region among the charge of the first photodiode into the second pixel signal; and
during a second time period after the first time period, convert a voltage corresponding to a charge of the storage area among the charge of the first photodiode into a third pixel signal.

7. The image sensor of claim 6, further comprising:
an analog-to-digital converter circuit configured to convert the first pixel signal, the second pixel signal, and the third pixel signal into a first digital signal, a second digital signal, and a third digital signal, respectively; and
a second column line connected to the second pixel signal generator circuit, and
wherein the second pixel signal generator circuit is configured to output the second pixel signal and the third pixel signal through the second column line to the analog-to-digital converter circuit.

8. The image sensor of claim 1, further comprising:
an analog-to-digital converter circuit configured to convert the first pixel signal into a first digital signal using a correlated double sampling method.

9. The image sensor of claim 8, wherein, based on the first mode signal, the first pixel signal generator circuit is configured to store a charge corresponding to a reset voltage in the first capacitor, and store a charge corresponding to a pixel voltage in the second capacitor.

10. The image sensor of claim 1, wherein the first mode signal and the second mode signal are activated at different times.

11. The image sensor of claim 1, wherein
the second pixel signal generator circuit includes:
a first transistor connected between the first photodiode and a floating diffusion node and having a gate configured to receive a transmission signal;
a second transistor connected between the floating diffusion node and a first node and having a gate configured to receive a first reset signal;
a third transistor connected between the first node and a first power terminal and having a gate configured to receive a second reset signal;
a fourth transistor connected between the first power terminal and a second power terminal and having a gate configured to receive a third reset signal; and
a tenth transistor connected between the first node and a storage node and having a gate configured to receive a second switch signal, and
at least one of the first capacitor and the second capacitor is connected in parallel between the storage node and the second power terminal.

12. The image sensor of claim 11, wherein, based on the second switch signal corresponding to a first mode signal, the tenth transistor is turned off, and based on the second switch signal corresponding to a second mode signal, the tenth transistor is turned on.

13. An image sensor comprising:
a first capacitor;
a second capacitor;
a first transistor connected between a photodiode and a floating diffusion node and having a gate configured to receive a transmission signal;
a second transistor connected between a first node and the floating diffusion node and having a gate configured to receive a first reset signal;
a third transistor connected between the first node and a first power terminal and having a gate configured to receive a second reset signal;
a fourth transistor connected between the first power terminal and a second power terminal and including a gate configured to receive a third reset signal;
a fifth transistor connected between a third power terminal and a second node and having a gate connected to the floating diffusion node;
a sixth transistor connected between the second node and a first column line and having a gate configured to receive a selection signal;
a seventh transistor connected between the second node and a storage node and having a gate configured to receive a switch signal;
an eighth transistor connected between the storage node and one end of the first capacitor and having a gate configured to receive a first sampling signal;
a ninth transistor connected between the storage node and one end of the second capacitor and having a gate configured to receive a second sampling signal; and
a tenth transistor connected between the first node and the second node, or connected between the first node and the storage node and having a gate configured to receive a second switch signal, and
another end of the first capacitor and another end of the second capacitor respectively connected to the second power terminal.

14. The image sensor of claim 13, wherein, based on a first mode signal, the fourth transistor and the tenth transistor are turned off, and the seventh transistor is turned on.

15. The image sensor of claim 13, wherein, based on a second mode signal, the seventh transistor is turned off, and the tenth transistor is turned on.

16. The image sensor of claim 13, wherein, based on a first mode signal, the fourth transistor and the tenth transistor are turned off, the seventh transistor is turned on,
wherein, based on a second mode signal, the seventh transistor is turned off, and the tenth transistor is turned on, and
wherein, the first mode signal and the second mode signal are activated at different times.

17. The image sensor of claim 13, wherein, based on a second mode signal, the seventh transistor is turned off, and the tenth transistor is turned on, and
wherein, based on the second mode signal, the second transistor is turned on and configured to increase a capacitance of the floating diffusion node.

18. An image capturing method includes:
determining whether to operate in a first method or a second method,
transmitting a first mode signal, based on determining to operate in the first method, or a second mode signal, based on determining to operate in the second method, to a pixel circuit,
collecting charges in a photodiode of the pixel circuit during an exposure time,
based on the pixel circuit receiving the first mode signal, storing charges of the floating diffusion region of the pixel circuit in a storage area of the pixel circuit, and converting a voltage corresponding to the stored charge into a first pixel signal,
based on the pixel circuit receiving the second mode signal, storing at least some of the floating diffusion region of the pixel circuit in the storage area of the pixel circuit, converting a voltage corresponding to the charge of the floating diffusion region into the second pixel signal, and converting a voltage corresponding to a charge of an extended floating diffusion region into the third pixel signal,
outputting at least one of the first to third pixel signals, and
converting the output at least one of the first to third pixel signals into respective digital signals.

19. The method of claim 18, wherein the storage area including a first capacitor and the second capacitor.

20. The method of claim 19, wherein, based on the second mode signal, a charge transfer path between at least one of the first capacitor and the second capacitor and a floating diffusion region, and the storage area is used as an expanded electrostatic capacitance of the floating diffusion region.
